(19) United States
(12) Patent Application Publication
(10) Pub. No.: US 2023/0184897 A1
(43) Pub. Date: Jun. 15, 2023

(54) LIDAR MICRO-ADJUSTMENT SYSTEMS AND METHODS

(71) Applicant: Boston Dynamics, Inc., Waltham, MA (US)

(72) Inventor: Erin Koksal, Cambridge, MA (US)

(73) Assignee: Boston Dynamics, Inc., Waltham, MA (US)

(21) Appl. No.: 17/992,279

(22) Filed: Nov. 22, 2022

Related U.S. Application Data
(60) Provisional application No. 63/288,318, filed on Dec. 10, 2021.

(51) Int. Cl. G01S 7/481; G01S 7/497; G01D 11/30

(52) U.S. Cl. CPC G01S 7/4813; G01S 7/4972; G01D 11/30; B25J 19/022

(57) ABSTRACT

An apparatus for decoupling angular adjustments about perpendicular axes is described herein. The apparatus comprises a first plate, a second plate offset from the first plate in a first direction, a first pivot disposed between the first and second plates, a second pivot disposed between the first and second plates. The second pivot is offset from the first pivot in a second direction perpendicular to the first direction. The third pivot is disposed between the first and second plates. The third pivot is offset from the first pivot in a third direction perpendicular to both the first and second directions. The apparatus further includes a first wedge at least partially disposed between the second pivot and the second plate. The first wedge is configured to adjust a first angle between the first and second plates, the first angle being about a first axis extending along the third direction.

### CROSS REFERENCE TO RELATED APPLICATIONS

This application claims the benefit under 35 U.S.C. § 119(e) of U.S. Provisional application Ser. No. 63/288,318, filed Dec. 10, 2021, and entitled, “LIDAR MICRO-ADJUSTMENT SYSTEMS AND METHODS,” the disclosure of which is incorporated by

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

For many mobile robotic systems, it is often desirable to adjust the angle between a light imaging detection and ranging (lidar) scan plane and the ground. Proper angular adjustment of a lidar scan plane can help ensure functionality of protective safety fields and/or enable accurate localization and mapping.

Lidar hardware is often located at extreme exterior positions of a mobile robot in order to achieve an unobstructed field of view. As a result, it can be desirable to shield the lidar hardware from collision with its environment using a protective barrier. The protective barrier typically includes an aperture to avoid interruption of the lidar field of view. However, the presence of a protective barrier creates a challenge for access to the angular adjustment of the lidar system.

The ability to adjust lidar pitch and roll while a protective barrier is in place enables an efficient workflow for installation and field service. Angular adjustment may be desirable during the initial construction of a robot, as part of a periodic maintenance cycle, or following an adverse event such as a collision between the robot and its environment. The independent adjustment of pitch and roll (vs. a coupled adjustment) further simplifies the alignment process by enabling iterative measurement of errors and subsequent adjustment along a single rotation axis.

The present disclosure describes an application directed toward a lidar system, but the systems and methods described herein may be applied more broadly to the angular adjustment of cameras, depth sensors, imaging systems, emitters of light or other electromagnetic radiation, or sensors more generally. Indeed, the systems and methods described herein may be applied to any system where the angular alignment between the component and its mount is important. The present disclosure describes an application directed toward a mobile robot, but the systems and methods described herein may also be applied to other mobile or stationary systems.

One aspect of the disclosure provides an apparatus for decoupled angular adjustments about perpendicular axes. The apparatus comprises a first plate and a second plate offset from the first plate in a first direction. The apparatus further comprises a first pivot disposed between the first and second plates; a second pivot disposed between the first and second plates, the second pivot offset from the first pivot in a second direction perpendicular to the first direction; and a third pivot disposed between the first and second plates, the third pivot offset from the first pivot in a third direction perpendicular to both the first and second directions. The apparatus further comprises a first wedge at least partially disposed between the second pivot and the second plate, the first wedge configured to adjust a first angle between the first and second plates, the first angle being about a first axis extending along the third direction.

In another aspect, the apparatus further comprises a first threaded rod configured to adjust a position of the first wedge along the second direction.

In another aspect, the apparatus further comprises a second wedge at least partially disposed between the third pivot and the second plate, the second wedge configured to adjust a second angle between the first and second plates, the second angle being about a second axis extending along the second direction.

In another aspect, the apparatus further comprises a first threaded rod configured to adjust a position of the first wedge along the second direction; and a second threaded rod configured to adjust a position of the second wedge along the second direction.

In another aspect, the first and second threaded rods are aligned with the second direction.

In another aspect, a first thread pitch of the first threaded rod is proportional to a first distance between the first and second pivots along the second direction, and a second thread pitch of the second threaded rod is proportional to a second distance between the first and third pivots along the third direction.

In another aspect, the first, second, and third pivots are ball bearings.

In another aspect, the first axis intersects the first and third pivots, and the second axis intersects the first and second pivots.

In another aspect, the apparatus further comprises a sensor coupled to either the first plate or the second plate.

In another aspect, the sensor comprises a distance sensor.

In another aspect, a sensing plane of the sensor intersects the first, second, and third pivots.

In another aspect, a sensing plane of the sensor intersects the first and second axes.

One aspect of the disclosure provides a sensor mount configured to adjust an orientation of a sensor. The sensor mount comprises a first plate; and a second plate offset from the first plate in a first direction. The second plate is configured to rotate relative to the first plate about a first axis perpendicular to the first direction. The second plate is configured to rotate relative to the first plate about a second axis perpendicular to both the first direction and the first axis. The second plate is configured to be coupled to the sensor. When the sensor is coupled to the second plate, a sensing plane of the sensor intersects the first and second axes.

In another aspect, the sensor is a distance sensor.

In another aspect, the sensor is a lidar sensor.

In another aspect, the sensor mount further comprises a first pivot disposed between the first and second plates; a second pivot disposed between the first and second plates, the second pivot offset from the first pivot in a second direction perpendicular to the first direction; and a third pivot disposed between the first and second plates, the third pivot offset from the first pivot in a third direction perpendicular to both the first and second directions.

In another aspect, the sensor mount further comprises a first wedge at least partially disposed between the second pivot and the second plate, the first wedge configured to adjust a first angle between the first and second plates, the first angle being about the first axis, the first axis extending along the third direction; and a second wedge at least partially disposed between the third pivot and the second plate, the second wedge configured to adjust a second angle between the first and second plates, the second angle being about the second axis, the second axis extending along the second direction.

In another aspect, the first axis intersects the first and third pivots, and the second axis intersects the first and second pivots.

In another aspect, the sensing plane intersects the first, second, and third pivots.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of one embodiment of a robot;

FIG. 1B is another perspective view of the robot of FIG. 1A;

FIG. 2A depicts robots performing tasks in a warehouse environment;

FIG. 2B depicts a robot unloading boxes from a truck;

FIG. 2C depicts a robot building a pallet in a warehouse aisle;

FIG. 3A is a top schematic view of one embodiment of an adjustable sensor mount;

FIG. 3B is a front schematic view of the adjustable sensor mount of FIG. 3A;

FIG. 4A is a perspective view of one embodiment of an adjustable sensor mount;

FIG. 4B is a perspective cross-sectional view of the adjustable sensor mount of FIG. 4A;

FIG. 4C is a perspective cross-sectional view of a portion of the adjustable sensor mount of FIG. 4A; and

FIG. 4D is a perspective cross-sectional view of a portion of the adjustable sensor mount of FIG. 4A.

### DETAILED DESCRIPTION

Robots are typically configured to perform various tasks in an environment in which they are placed. Generally, these tasks include interacting with objects and/or the elements of the environment. Notably, robots are becoming popular in warehouse and logistics operations. Before the introduction of robots to such spaces, many operations were performed manually. For example, a person might manually unload boxes from a truck onto one end of a conveyor belt, and a second person at the opposite end of the conveyor belt might organize those boxes onto a pallet. The pallet may then be picked up by a forklift operated by a third person, who might drive to a storage area of the warehouse and drop the pallet for a fourth person to remove the individual boxes from the pallet and place them on shelves in the storage area. More recently, robotic solutions have been developed to automate many of these functions. Such robots may either be specialist robots (i.e., designed to perform a single task, or a small number of closely related tasks) or generalist robots (i.e., designed to perform a wide variety of tasks). To date, both specialist and generalist warehouse robots have been associated with significant limitations, as explained below.

A specialist robot may be designed to perform a single task, such as unloading boxes from a truck onto a conveyor belt. While such specialist robots may be efficient at performing their designated task, they may be unable to perform other, tangentially related tasks in any capacity. As such, either a person or a separate robot (e.g., another specialist robot designed for a different task) may be needed to perform the next task(s) in the sequence. As such, a warehouse may need to invest in multiple specialist robots to perform a sequence of tasks, or may need to rely on a hybrid operation in which there are frequent robot-to-human or human-to-robot handoffs of objects.

In contrast, a generalist robot may be designed to perform a wide variety of tasks, and may be able to take a box through a large portion of the box's life cycle from the truck to the shelf (e.g., unloading, palletizing, transporting, depalletizing, storing). While such generalist robots may perform a variety of tasks, they may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible. Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task. As should be appreciated from the foregoing, the mobile base and the manipulator in such systems are effectively two separate robots that have been joined together; accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while there are limitations that arise from a purely engineering perspective, there are additional limitations that must be imposed to comply with safety regulations. For instance, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not a pose a threat to the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, the inventors have recognized and appreciated that a highly integrated mobile manipulator robot with system-level mechanical design and holistic control strategies between the manipulator and the mobile base may be associated with certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

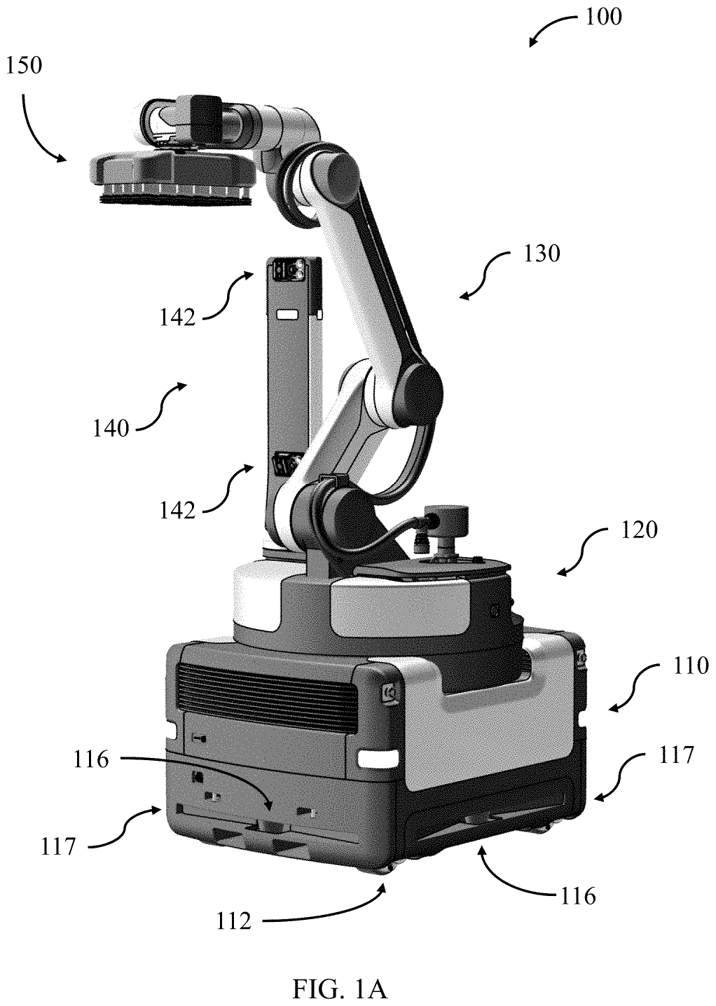

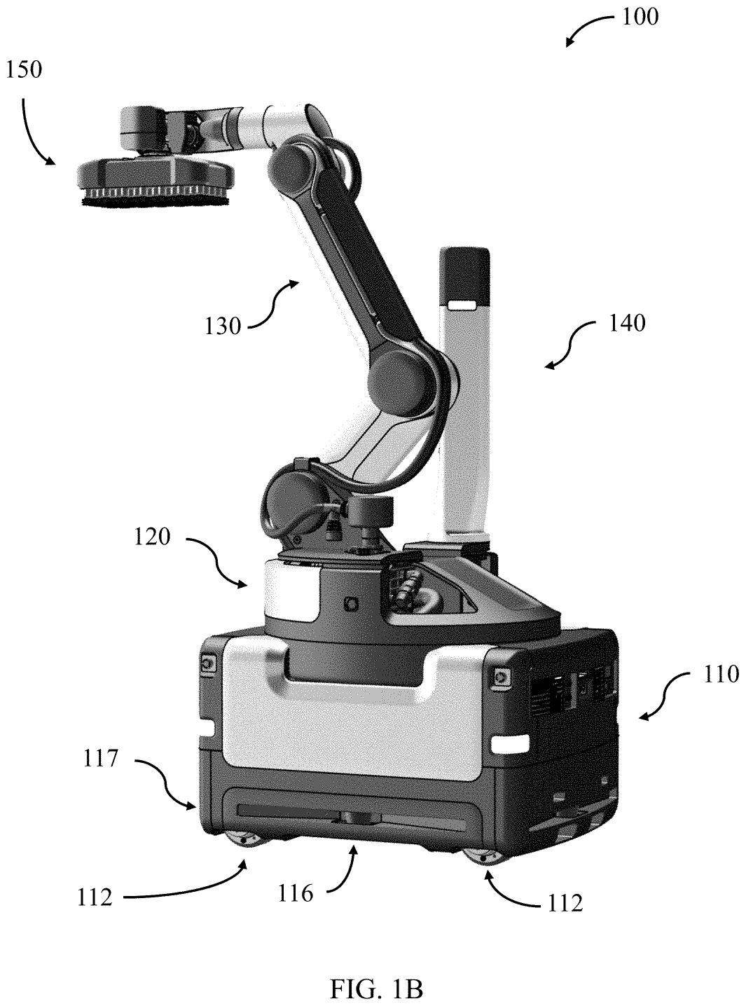

FIGS. 1A and 1B are perspective views of one embodiment of a robot 100. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

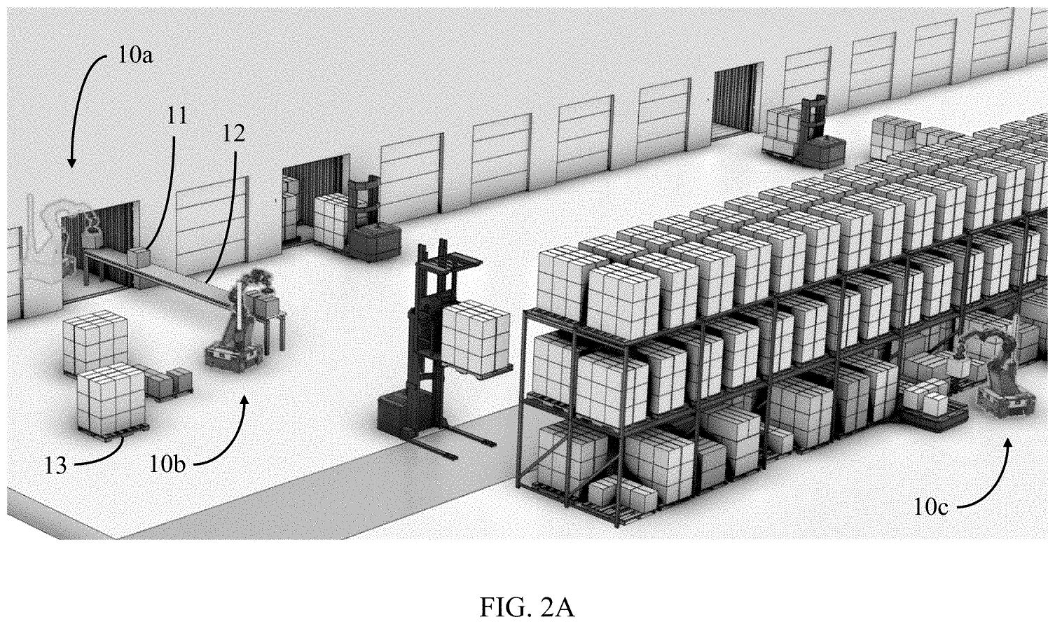

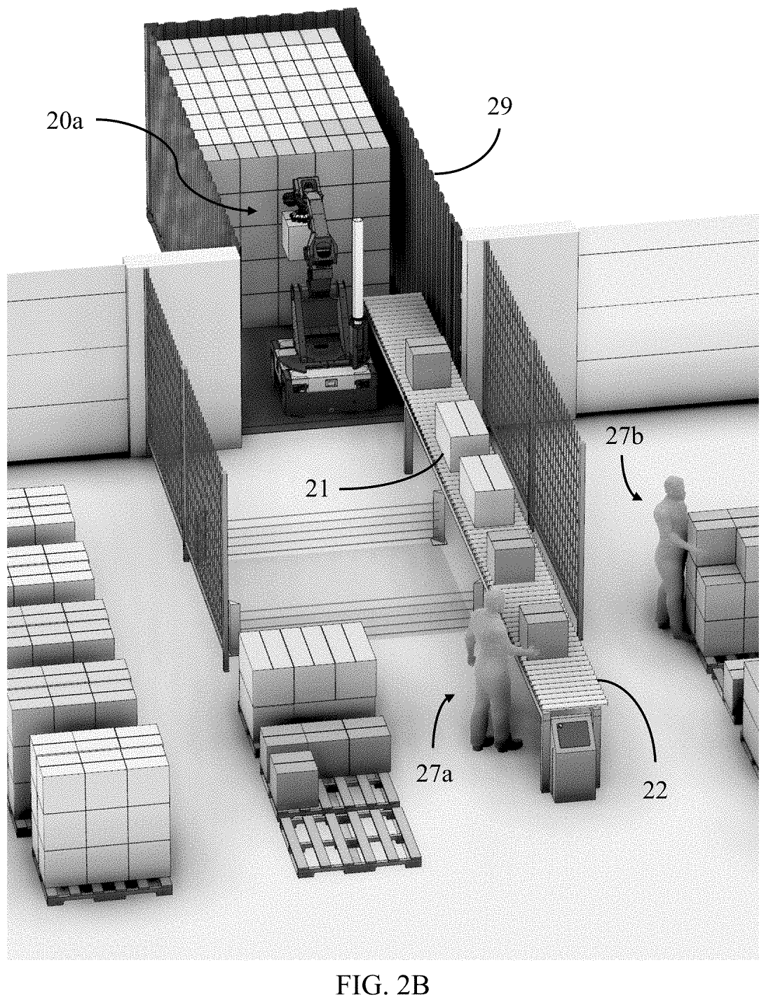

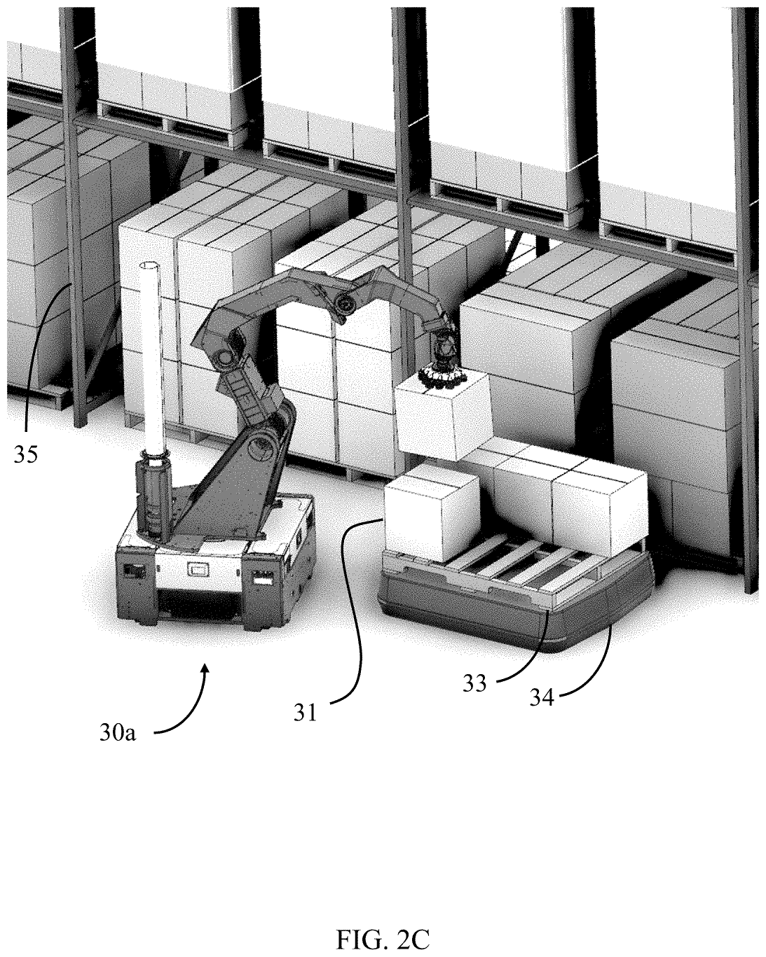

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). It should be appreciated that the robots 10a, 10b, and 10c are different instances of the same robot (or of highly similar robots). Accordingly, the robots described herein may be understood as specialized multi-purpose robots, in that they are designed to perform specific tasks accurately and efficiently, but are not limited to only one or a small number of specific tasks.

FIG. 2B depicts a robot 20a unloading boxes 21 from a truck 29 and placing them on a conveyor belt 22. In this box picking application (as well as in other box picking applications), the robot 20a will repetitiously pick a box, rotate, place the box, and rotate back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B. During operation, the perception mast of robot 20a (analogous to the perception mast 140 of robot 100 of FIGS. 1A and 1B) may be configured to rotate independent of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety zone around the robot into which humans are prevented from entering.

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

Of course, it should be appreciated that the tasks depicted in FIGS. 2A-2C are but a few examples of applications in which an integrated mobile manipulator robot may be used, and the present disclosure is not limited to robots configured to perform only these specific tasks. For example, the robots described herein may be suited to perform tasks including, but not limited to, removing objects from a truck or container, placing objects on a conveyor belt, removing objects from a conveyor belt, organizing objects into a stack, organizing objects on a pallet, placing objects on a shelf, organizing objects on a shelf, removing objects from a shelf, picking objects from the top (e.g., performing a “top pick”), picking objects from a side (e.g., performing a “face pick”), coordinating with other mobile manipulator robots, coordinating with other warehouse robots (e.g., coordinating with AMRs), coordinating with humans, and many other tasks.

### Example Sensor Mount

In some embodiments, a mobile base may include sensors to help the mobile base navigate its environment. In the embodiment shown in FIGS. 1A and 1B, the mobile base 110 of the robot 100 includes distance sensors 116. The mobile base includes at least one distance sensor 116 on each side of the mobile base 110. A distance sensor may include a camera, a time of flight sensor, a lidar sensor, or any other sensor configured to sense information about the environment from a distance. In embodiments of a mobile base that include distance sensors with an associated field of view (e.g., cameras, lidar sensors), the fields of view of the distance sensors may overlap to provide a full 360-degree view of the environment around the robot. For example, a mobile base may be rectangular, and each of the four sides may include a distance sensor. The locations of the distance sensors and the associated fields of view may be arranged such that the field of view of each distance sensor at least partially overlaps the fields of view of the two neighboring distance sensors. In some embodiments, fields of view may not overlap continuously to enable full 360-degree sensing, but, nonetheless, at least one field of view may at least partially overlap a second field of view. In some embodiments, a field of view may be represented by an angular value and/or a distance. In some embodiments, a field of view may be represented by a sector of a circle.

Often, a distance sensor with an associated field of view may be located at a periphery of a robot (e.g., at or near an edge of a mobile base) to minimize occlusions and enable an unobstructed field of view. However, due to the sensor's exposed position on the robot, the sensor may be susceptible to damage, such as from a collision between the robot and an object in its environment. Accordingly, a protective barrier may be installed around the sensor to protect it from damage. To avoid occluding the field of view of the sensor being protected, the barrier may include one or more apertures. In this way, the barrier may protect the sensor without introducing additional occlusions in the field of view of the sensor. See, for example, distance sensors 116 in FIGS. 1A and 1B, which are protected by the body of the mobile base 110. The mobile base 110 includes apertures 117 to enable an unobstructed field of view for distance sensors 116.

While a barrier that protects an otherwise exposed sensor may be associated with certain benefits, some challenges may arise. For example, physical access to the sensor may be impeded by the presence of the protective barrier, limiting the ease and/or convenience with which adjustments to the sensor may be made. Some types of sensor adjustments may be made regularly, such that increasing the ease with which such adjustments may be made may be associated with significant improvements in workflow and decreases in maintenance times. For example, angular adjustments to a distance sensor with an associated field of view (e.g., adjustments to sensor pitch and/or roll) may be performed frequently, such as after a collision, as part of routine maintenance, and during initial installation.

In view of the above, the inventors have recognized and appreciated the benefits associated with a sensor mount that facilitates simple, convenient, and accurate adjustments to be made to the sensor. Such a sensor mount may be particularly advantageous in applications in which the physical accessibility of the sensor and/or the sensor mount may be limited. Returning to the example of the robot 100 with distance sensors 116 in FIGS. 1A and 1B, a sensor mount may enable adjustments to the distance sensor 116 through the aperture 117 of the protective barrier. Furthermore, the inventors have appreciated the benefits associated with a sensor mount that decouples the angular adjustments made to different sensing axes of a distance sensor. As such, a user may independently adjust each of two different sensing axes (e.g., pitch and roll), as will be explained in greater detail below. Additionally, the inventors have appreciated the benefits associated with a sensor mount that aligns the sensing plane of the sensor with the axes about the sensor is adjusted. As such, adjusting a given sensor angle (e.g., pitch) may not additionally adjust a linear position of the sensing plane (e.g., a height above the ground).

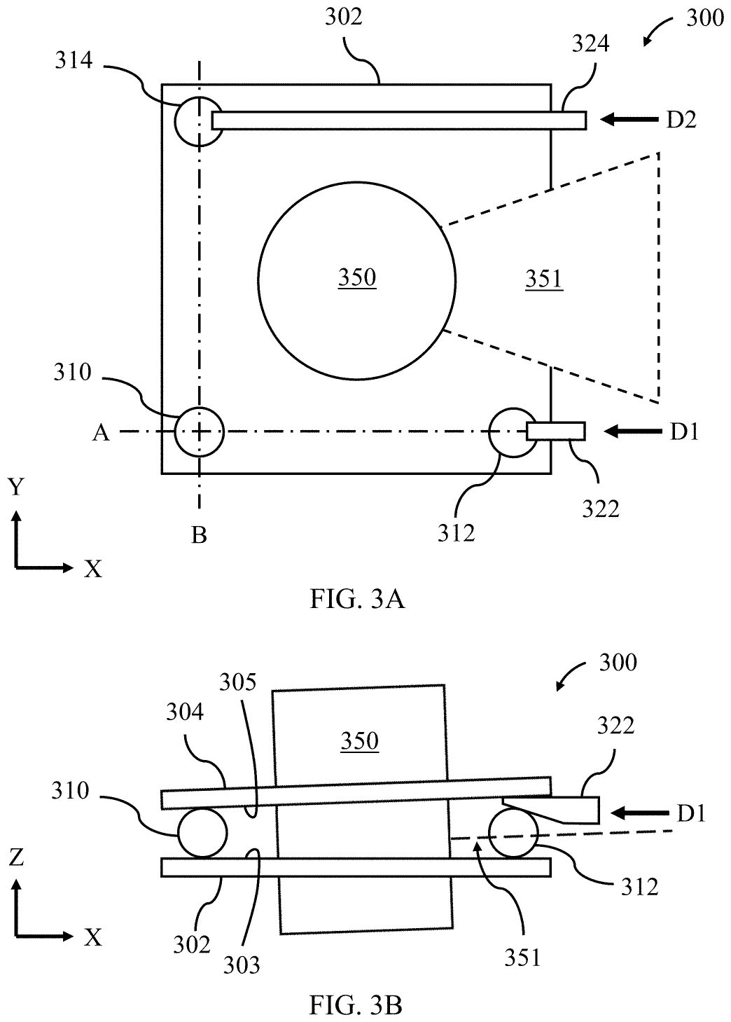

FIGS. 3A and 3B depict schematic views of one embodiment of an adjustable sensor mount 300. FIG. 3A depicts a top view, while FIG. 3B depicts a front view. The sensor mount 300 includes a bottom plate 302 and a top plate 304 (not shown in FIG. 3A, for clarity) offset from the bottom plate in the vertical direction (e.g., offset in a direction aligned with the Z axis). The bottom plate 302 is stationary, while the top plate 304 is free to translate and/or rotate relative to the bottom plate 302. In some embodiments, the top plate 304 may be constrained from translating in the X and/or Y directions. In some embodiments, the top plate 304 may be constrained from rotating about the Z axis.

The two plates are biased toward one another, for example using one or more springs (not shown, for clarity). For example, the top plate 304 may be moveable and may be biased toward the bottom plate 302, which may be stationary. Absent any components disposed between the two plates, the biasing force may urge the top plate 304 down (e.g., in a negative Z direction) until a bottom surface 305 of the top plate 304 contacts a top surface 303 of the bottom plate 302. However, as described below, the sensor mount 300 includes components disposed between the two plates, preventing such contact between the plates.

A first ball bearing 310 is disposed between the two plates 302 and 304. A second ball bearing 312, also disposed between the two plates 302 and 304, is spaced from the first ball bearing 310 in the X direction. Similarly, a third ball bearing 314, also disposed between the two plates 302 and 304, is spaced from the first ball bearing 310 in the Y direction. As shown in FIG. 3A, axis A extends between the first ball bearing 310 and the second ball bearing 312, and axis B extends between the first ball bearing 310 and the third ball bearing 314.

The orientation of the top plate 304 may be defined, at least in part, by the three ball bearings. Without wishing to be bound by theory, the top plate 304 may be parallel to the bottom plate 302 if the distance between the two plates (e.g., the distance along the Z direction) is constant regardless of position (e.g., independent of X-Y position). Accordingly, if the three ball bearings are the same size, the top plate 304 may be parallel to the bottom plate 302.

It should be appreciated that, in other embodiments, different components may be disposed between the two plates in place of ball bearings to control the relative orientation of the top plate relative to the bottom plate. Without wishing to be bound by theory, a curved surface may contact a flat surface at a single point. Accordingly, rounded or spherical components may be advantageous in certain embodiments. However, any component that provides a pivot about which one plate may rotate relative to the other plate may be appropriate, and the present disclosure is not limited in this regard. For example, a threaded fastener with a rounded tip may be used as a pivot in some embodiments.

The sensor mount 300 additionally includes a first wedge 322 disposed at least partially between the second ball bearing 312 and the second plate 304. As the first wedge 322 is inserted in the direction D1 indicated in FIGS. 3A and 3B (e.g., in a negative X direction), the first wedge 322 drives the top plate 304 upward (e.g., in a vertical Z direction) against the biasing force at the X-Y location of the second ball bearing 312. Accordingly, the top plate 304 rotates about the B axis in a first rotational direction. As the first wedge 322 is retracted (e.g., opposite the direction D1), the biasing force restores the top plate 304 toward its original orientation by rotating the top plate 304 about the B axis in a second rotational direction opposite the first rotational direction. In some embodiments, a similar effect may be achieved if the first wedge 322 were instead disposed between the first ball bearing 312 and the bottom plate 302. In some embodiments, other mechanisms and/or arrangements of components may be configured to be adjusted to increase the distance between the first plate 302 and the second plate 304 at a position of the second ball bearing 312, and the disclosure is not limited in this regard.

The sensor mount 300 additionally includes a second wedge 324 disposed at least partially between the third ball bearing 314 and the second plate 304. In a manner largely analogous to the operation of the first wedge 322, inserting or retracting the second wedge 324 (e.g., displacing the second wedge 324 in the direction D2 or opposite the direction D2, respectively) rotates the top plate 304 relative to the bottom plate 302 about the A axis in opposite directions.

Notably, the first wedge 322 and the second wedge 324 are both accessed from the same side of the sensor mount 300 (e.g., from the right side in FIGS. 3A and 3B). When a sensor 350 is coupled to the sensor mount 300 (e.g., coupled to the top plate 304), the sensor 350 may be oriented with its sensing plane 351 facing the same side of the sensor mount 300 as the side from which the wedges are accessed. As such, adjusting the first wedge 322 may adjust the pitch of the sensor 350, and adjusting the second wedge 324 may adjust roll of the sensor 350. In this configuration, if a protective barrier is installed around the sensor 350 with an aperture to accommodate the sensing plane 351, the first and second wedges may be accessed through the same aperture to adjust the pitch and roll of the sensor 350 and the sensing plane 351.

Although FIGS. 3A and 3B depict an embodiment of a sensor mount that includes independent pitch and roll adjustment mechanisms, it should be appreciated that other embodiments of a sensor mount may include only a pitch adjustment mechanism or only a roll adjustment mechanism. For example, an embodiment of a sensor mount that includes only a pitch adjustment mechanism may closely resemble the embodiment of FIGS. 3A and 3B, but without the second wedge 324. Similarly, an embodiment of a sensor mount that includes only a roll adjustment mechanism may closely resemble the embodiment of FIGS. 3A and 3B, but without the first wedge 322. Accordingly, a sensor mount may only include a single wedge in some embodiments.

Although wedges 322 and 324 are depicted in FIGS. 3A and 3B as extending from their respective ball bearings past the edge of the plates, it should be appreciated that the wedges may instead be driven by push rods. Examples of push rods include but are not limited to: fine pitch threaded fasteners, coarse pitch threaded fasteners, or differential screws. In this way, the linear position of the first and second wedges 322 and 324 along their directions D1 and D2 (respectively) may be adjusted by rotating an associated threaded fastener (or other push rod). Because the linear position of the wedges controls the angular orientation of the sensor 350 and the sensing plane 351, a correlation between the rotation of a threaded fastener and an angular adjustment of the sensing plane may be determined. For example, rotating a first threaded fastener associated with the first wedge 322 by α1 degrees may induce a pitch of the sensing plane 351 of β1 degrees. Similarly, rotating a second threaded fastener associated with the second wedge 324 by α2 degrees may induce a roll of the sensing plane 351 of β2 degrees. The pitches of the first and second threaded fasteners may be selected (e.g., based on the angles of the wedges and the distances between the ball bearings) such that rotating either fastener by a given amount induces a desired angular change in the sensing plane. In some embodiments, thread pitches may be selected to induce the same angular change in the sensing plane regardless of whether pitch or roll is adjusted. For example, by selecting an appropriate combination of thread pitches, wedge angles, and ball bearing distances, rotating the first threaded fastener by α3 degrees may induce a pitch of the sensing plane 351 of β3 degrees, and rotating the second threaded fastener by the same α3 degrees may similarly induce a roll of the sensing plane 351 of β3 degrees.

Regardless of the specific relationship between the angular rotation of the threaded fastener and the angular change in pitch or roll of the sensor and sensing plane, the relationship may nonetheless be deterministic, repeatable, and reliable. Such features may be associated with certain benefits. For example, after the misalignment of a sensor in pitch and/or roll is determined, instructions may be provided to sensor maintenance personnel that are simple and precise. In contrast to conventional sensor mounts in which adjusting pitch and roll to realign the sensor may be a tedious, iterative process of alternatingly making an adjustment and checking alignment, adjustments to the sensor mount described herein may be simpler. With pitch and roll decoupled, each axis may be adjusted independently. With a known relationship between the angular rotation of the threaded fastener and the angular change in the sensing plane, specific instructions (e.g., turn the screw three rotations clockwise) may be given to correct a known misalignment along a given axis.

In some embodiments, a misalignment may be corrected with a single realignment action (e.g., rotate a particular fastener a certain number of degrees). In some embodiments, iterative measurement of a misalignment and execution of one or more realignment actions may be appropriate. For example, a first misalignment measurement may be made, and a coarse realignment action may be performed. Subsequently, a second misalignment measurement may be made, and a fine realignment action may be performed. Regardless of the particular number of misalignment measurements and/or realignment actions that may be appropriate, it should be appreciated that, compared to conventional sensor mounts, the predictable and well-characterized relationship between the angular rotation of a threaded fastener and the angular change in pitch or roll of the sensor and sensing plane of the sensor mounts described herein may reduce the time and/or effort of realigning a sensor.

In some embodiments of a sensor mount with three ball bearings (or other pivots) disposed between two plates, the three ball bearings may form (or may approximately form) a kinematic coupling designed to constrain all degrees of freedom of the system (e.g., the position and orientation of a top plate relative to a bottom plate) without over-constraining the system. As an example of an over-constrained system, some conventional sensor mounts include three threaded fasteners extending through a first plate and threaded into three parallel threaded holes in a second plate. In these conventional sensor mounts, adjusting one or more of the threaded fasteners may adjust the position and/or orientation of the first plate relative to the second plate, but may also introduce significant stress and/or strain into one or both of the plates. The stress and/or strain in the plate(s) may introduce significant hysteresis and may lower repeatability and predictability of the system. In contrast, the sensor mounts described herein may not include kinematically over-constrained systems, thereby increasing repeatability and predictability relative to many conventional sensor mounts.

To further aid the realignment process, the sensor mount 300 may be configured such that when the sensor 350 is mounted to the top plate 304, the sensing plane 351 is aligned with the rotation axes A and B of the sensor mount 300. In this way, adjusting the pitch and/or roll of the sensor does not induce an additional vertical offset of the sensor (e.g., along the Z direction), as may be the case if the rotation axes A and B were vertically offset from the sensing plane 351 (as is the case in many conventional sensor mounts).

While the three ball bearings 310, 312, and 314 are depicted as being the same size in FIGS. 3A and 3B, the present disclosure is not limited in this regard. Without wishing to be bound by theory, if the ball bearings are the same size, the minimum pitch or roll angle of the top plate relative to the bottom plate may be 0 degrees (e.g., corresponding to when the two wedges are fully retracted and introduce no additional offset between the top plate and the respective ball bearing). In some embodiments, the ball bearings may be different sizes. For example, if the first ball bearing 310 is larger than the second and third ball bearings 312 and 314, the sensing plane 351 may achieve both negative pitch and roll values when the respective wedges are fully retracted. As such, the sensing plane 351 may be adjusted to achieve both positive and negative values of pitch and roll relative to a horizontal plane.

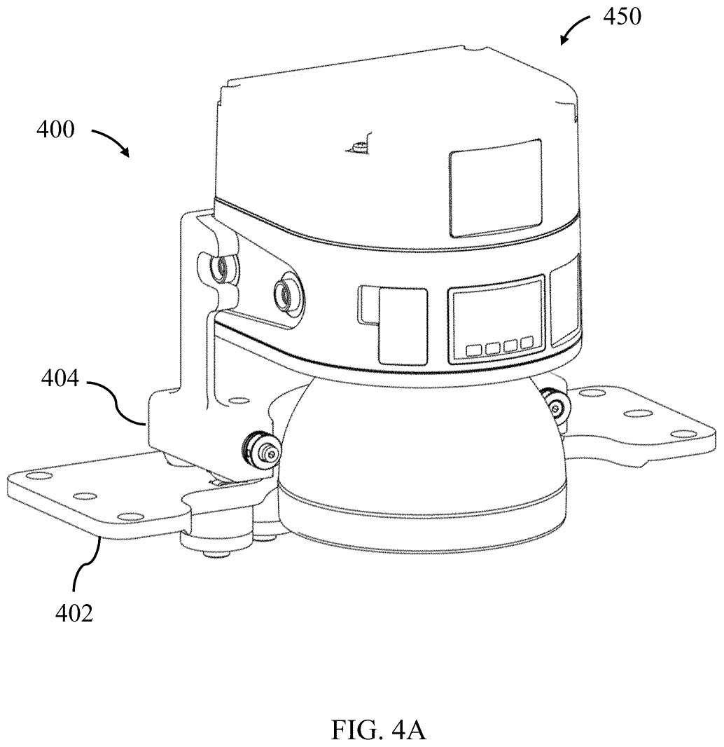

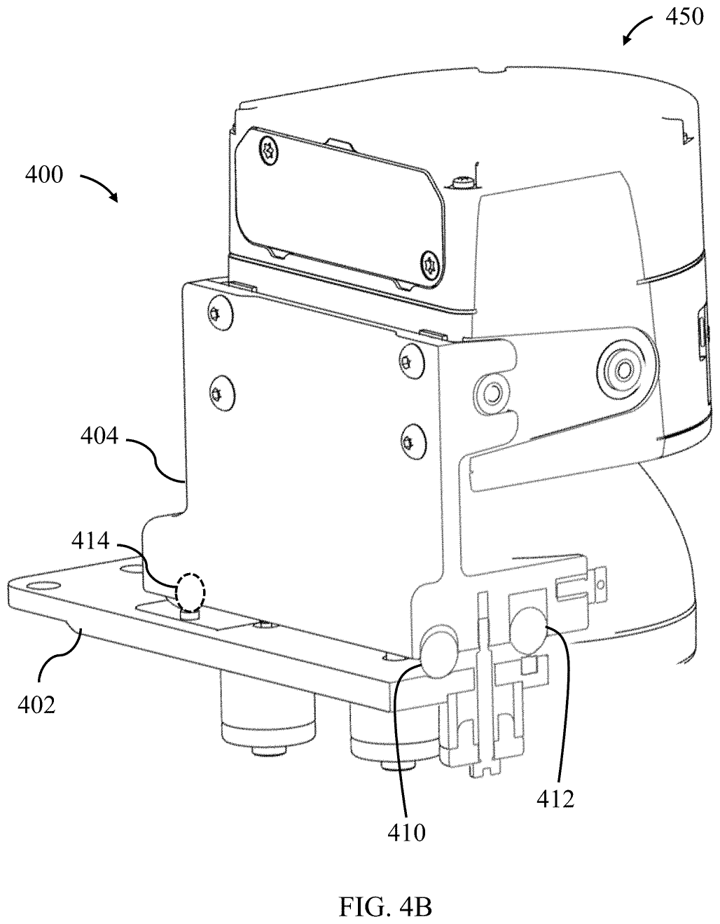

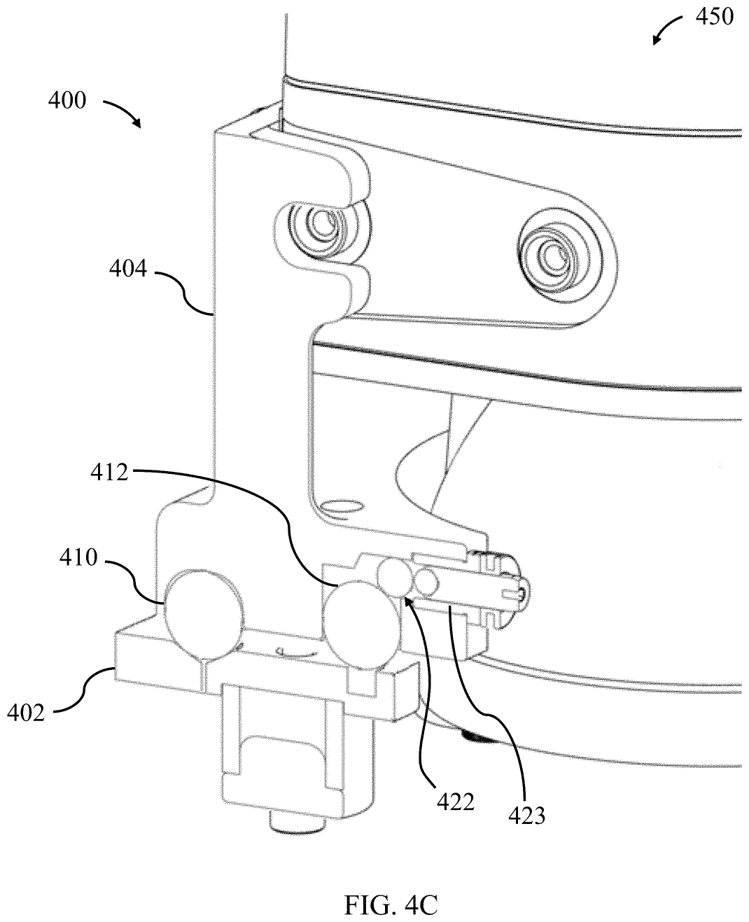

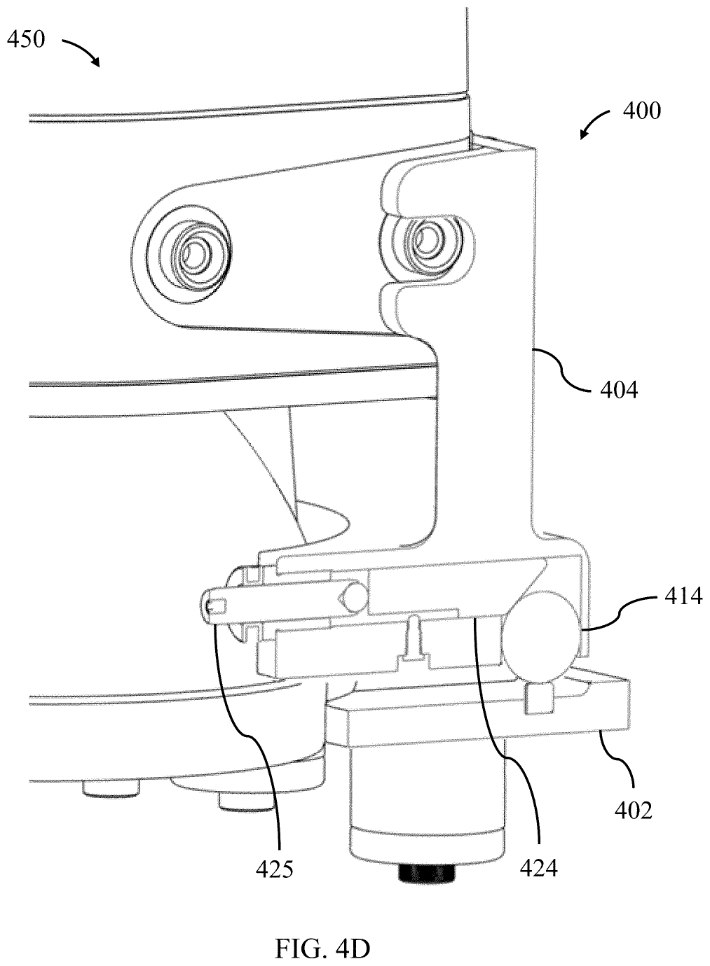

FIGS. 4A-4D depict another embodiment of a sensor mount 400, on which is mounted a lidar sensor 450. The sensor mount 400 includes a bottom plate 402 and a top plate 404. While the top plate 404 includes a more complicated geometry than the top plate 302 depicted in the schematics of FIGS. 3A and 3B, one of skill in the art will recognize that a salient feature of the top plate is a substantially flat bottom surface (in combination with a substantially flat top surface of the bottom plate).

As shown in the cross-sectional view of FIG. 4B, the sensor mount 400 includes a first ball bearing 410, a second ball bearing 412, and a third ball bearing 414 (the third ball bearing 414 is dashed out in FIG. 4B, as it is occluded by the top plate 404). As best seen in FIG. 4C, the pitch of the sensor 450 is adjusted by adjusting the position of a first wedge 422. In contrast to the angled first wedge 322 depicted in the schematics of FIGS. 3A and 3B, the first wedge 422 includes one or more components that are physically constrained to perform the function of a wedge. As a push rod, such as a first threaded fastener 423, is advanced, the first wedge 422 adjusts the offset of the second plate 404 from the second ball bearing 412, thereby adjusting pitch. In the embodiment of FIGS. 4A-4D, the first wedge 422 comprises a ball bearing constrained to travel within an internal geometry of the second plate 404. Additionally, the first threaded fastener 423 includes a ball bearing at its distal end to ensure a single point of contact with the ball bearing of the first wedge 422. As best seen in FIG. 4D, the roll of the sensor 450 is adjusted by adjusting the position of a second wedge 424. The second wedge 424 is advanced by a push rod such as a second threaded fastener 425. The first and second threaded fasteners may be locked (e.g., using a locking nut) to lock the desired roll and pitch angles after adjustment.

Control of one or more of the robotic arm, the mobile base, the turntable, and the perception mast may be accomplished using one or more computing devices located on-board the mobile manipulator robot. For instance, one or more computing devices may be located within a portion of the mobile base with connections extending between the one or more computing devices and components of the robot that provide sensing capabilities and components of the robot to be controlled. In some embodiments, the one or more computing devices may be coupled to dedicated hardware configured to send control signals to particular components of the robot to effectuate operation of the various robot systems. In some embodiments, the mobile manipulator robot may include a dedicated safety-rated computing device configured to integrate with safety systems that ensure safe operation of the robot.

The computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the terms “physical processor” or “computer processor” generally refer to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that embodiments of a robot may include at least one non-transitory computer-readable storage medium (e.g., a computer memory, a portable memory, a compact disk, etc.) encoded with a computer program (i.e., a plurality of instructions), which, when executed on a processor, performs one or more of the above-discussed functions. Those functions, for example, may include control of the robot and/or driving a wheel or arm of the robot. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. An apparatus for decoupled angular adjustments about perpendicular axes, the apparatus comprising:
a first plate;
a second plate offset from the first plate in a first direction;
a first pivot disposed between the first and second plates;
a second pivot disposed between the first and second plates, the second pivot offset from the first pivot in a second direction perpendicular to the first direction;
a third pivot disposed between the first and second plates, the third pivot offset from the first pivot in a third direction perpendicular to both the first and second directions; and
a first wedge at least partially disposed between the second pivot and the second plate, the first wedge configured to adjust a first angle between the first and second plates, the first angle being about a first axis extending along the third direction.

2. The apparatus of claim 1, further comprising a first threaded rod configured to adjust a position of the first wedge along the second direction.

3. The apparatus of claim 1, further comprising a second wedge at least partially disposed between the third pivot and the second plate, the second wedge configured to adjust a second angle between the first and second plates, the second angle being about a second axis extending along the second direction.

4. The apparatus of claim 3, further comprising:
a first threaded rod configured to adjust a position of the first wedge along the second direction; and
a second threaded rod configured to adjust a position of the second wedge along the second direction.

5. The apparatus of claim 4, wherein the first and second threaded rods are aligned with the second direction.

6. The apparatus of claim 4, wherein:
a first thread pitch of the first threaded rod is proportional to a first distance between the first and second pivots along the second direction, and
a second thread pitch of the second threaded rod is proportional to a second distance between the first and third pivots along the third direction.

7. The apparatus of claim 1, wherein the first, second, and third pivots are ball bearings.

8. The apparatus of claim 1, wherein:
the first axis intersects the first and third pivots, and
the second axis intersects the first and second pivots.

9. The apparatus of claim 1, further comprising a sensor coupled to either the first plate or the second plate.

10. The apparatus of claim 9, wherein the sensor comprises a distance sensor.

11. The apparatus of claim 9, wherein a sensing plane of the sensor intersects the first, second, and third pivots.

12. The apparatus of claim 9, wherein a sensing plane of the sensor intersects the first and second axes.

13. A sensor mount configured to adjust an orientation of a sensor, the sensor mount comprising:
a first plate; and
a second plate offset from the first plate in a first direction, the second plate configured to rotate relative to the first plate about a first axis perpendicular to the first direction, the second plate configured to rotate relative to the first plate about a second axis perpendicular to both the first direction and the first axis, and the second plate configured to be coupled to the sensor,
wherein when the sensor is coupled to the second plate, a sensing plane of the sensor intersects the first and second axes.

14. The sensor mount of claim 13, wherein the sensor is a distance sensor.

15. The sensor mount of claim 13, wherein the sensor is a lidar sensor.

16. The sensor mount of claim 13, further comprising:
a first pivot disposed between the first and second plates;
a second pivot disposed between the first and second plates, the second pivot offset from the first pivot in a second direction perpendicular to the first direction; and
a third pivot disposed between the first and second plates, the third pivot offset from the first pivot in a third direction perpendicular to both the first and second directions.

17. The sensor mount of claim 16, further comprising:
a first wedge at least partially disposed between the second pivot and the second plate, the first wedge configured to adjust a first angle between the first and second plates, the first angle being about the first axis, the first axis extending along the third direction; and
a second wedge at least partially disposed between the third pivot and the second plate, the second wedge configured to adjust a second angle between the first and second plates, the second angle being about the second axis, the second axis extending along the second direction.

18. The sensor mount of claim 16, wherein:
the first axis intersects the first and third pivots, and
the second axis intersects the first and second pivots.

19. The sensor mount of claim 16, wherein the sensing plane intersects the first, second, and third pivots.
